(19) United States
(12) Patent Application Publication
(10) Pub. No.: US 2008/0202704 A1
(43) Pub. Date: Aug. 28, 2008

(54) Vertical blind carrier

(76) Inventor: Ya-Yin Lin, Chia-Yi Hsien (TW)

Correspondence Address: JACOBSON HOLMAN PLLC, 400 SEVENTH STREET N.W., SUITE 600, WASHINGTON, DC, 20004, US

(21) Appl. No.: 11/710,997

(22) Filed: Feb. 27, 2007

(51) Int. Cl. E06B 9/36

(52) U.S. Cl. 160/168.1 V

(57) ABSTRACT

A carrier is adapted for a vertical blind assembly that includes an elongate blind headrail extending in a longitudinal direction, a spacer unit and a vertical slat. The spacer unit includes two spacer rods intersecting each other. The carrier includes a carrier body configured with an inner receiving space and having a top side formed with a top opening in spatial communication with the inner receiving space, a bottom side, opposite lateral sides, and front and rear sides each being disposed with a rolling wheel that is engaged slidably in the blind headrail. A pivot seat is mounted detachably on the top side of the carrier body, and has an upright pivot pin connected pivotally to intersecting portions of the spacer rods. A slat-holding member is mounted detachably on the bottom side and holds the vertical slat.

### BACKGROUND OF THE INVENTION

1. Field of the Invention

The invention relates to a vertical blind, more particularly to a vertical blind carrier.

2. Description of the Related Art

FIGS. 1 and 2 illustrate a vertical blind assembly that includes an elongate blind headrail 11 disposed fixedly above a window 10, a plurality of conventional carriers 12 disposed movably inside the blind headrail 11, a plurality of elongate spacer plates 13 each interconnecting a corresponding adjacent pair of the carriers 12, and a plurality of vertical slats 14 each being held by a corresponding one of the carriers 12. A cord 127 is attached to a leading carrier 12 (i.e., the left one in FIG. 1), and can be pulled to move the carriers 12 within the blind headrail 11 to a desired one of extended and retracted positions.

Each conventional carrier 12 includes a carrier body 122, two rolling wheels 125 mounted pivotally and respectively on front and rear sides of the carrier body 122 and engaged slidably in the blind headrail 11, and a slat-holding member 126 mounted on a bottom side of the carrier body 122 and holding the corresponding one of the vertical slats 14. The top side of the carrier body 122 of each carrier 12 is formed with a receiving groove 124 that extends between opposite lateral sides and that is defined by front and rear walls 1241, 1242 each being formed with an inverted L-shaped engaging block 128.

Each spacer plate 13 extends through the receiving grooves 124 in the carrier bodies 122 of the corresponding adjacent pair of the carriers 12, and has opposite first and second ends 130, 131 formed respectively with two upright engaging protrusions 132 and two horizontal protrusions 133 that abut respectively against the engaging blocks 128 of the carrier bodies 122 of the corresponding adjacent pair of the carriers 12 so as to limit a maximum distance between the corresponding adjacent pair of the carriers 12.

When the leading carrier 12 is pulled and moved by the cord 127 to move in an extended direction during an extending operation, each of the carriers 12 other than the leading one does not move until it is at the maximum distance from an adjacent carrier 12 at the leading side. On the other hand, when the leading carrier 12 is pulled by the cord 127 to move in a retracting direction during a retracting operation, each of the carriers 12 other than the leading one does not move back until it is collided by the adjacent carrier 12 at the leading side.

FIG. 3 illustrates another vertical blind assembly, which differs from that of FIG. 1 in that a plurality of spacer units 15 replace the spacer plates 13 of FIG. 1, and that conventional carriers 12′ replace the carriers 12 of FIG. 1. Each spacer unit 15 includes two spacer rods 152 intersecting each other. In the vertical blind assembly of FIG. 3, each carrier 12′ includes a carrier body 122′, two rolling wheels mounted pivotally on front and rear sides of the carrier body 122′ and engaged slidably in the blind headrail 11, a pivot pin 129 fixed on a top side of the carrier body 122′ and connected pivotally to intersecting portions of the spacer rods 152 of a corresponding one of the spacer units 15, and a slat-holding member 126 mounted on a bottom side of the carrier body 122′ and holding a corresponding vertical slat 14. It is noted that ends of the spacer rods 152 of each spacer unit 15 are connected pivotally and respectively to corresponding ends of the spacer rods 152 of an adjacent spacer unit 15. In such a configuration, the carriers 12′ can be pulled by the cord 127 to move within the blind headrail 11 to a desired one of extended and retracted positions, wherein the distance between each adjacent pair of the carriers 12′ is uniform.

In actual use, the aforesaid conventional carriers 12, 12′ correspond respectively to the spacer plates 13 and the spacer rods 152, thereby resulting in limited applicability. Furthermore, the carriers 12, 12′ are undetachable, thereby resulting in inconvenience during repair.

### SUMMARY OF THE INVENTION

Therefore, the object of the present invention is to provide a carrier adapted for a vertical blind assembly that can be easily assembled, disassembled and repaired, and that is compatible with vertical blind assemblies having different spacer members.

According to the present invention, there is provided a carrier adapted for a vertical blind assembly that includes an elongate blind headrail extending in a longitudinal direction, a spacer unit and a vertical slat. The spacer unit includes two spacer rods intersecting each other. The carrier comprises:

a carrier body configured with an inner receiving space and having a top side formed with a top opening in spatial communication with the inner receiving space, a bottom side, opposite lateral sides, and front and rear sides each being disposed with a rolling wheel that is adapted to be engaged slidably in the blind headrail;

a pivot seat mounted detachably on the top side of the carrier body and having an upright pivot pin adapted to be connected pivotally to intersecting portions of the spacer rods; and

a slat-holding member mounted detachably on the bottom side and adapted to hold the vertical slat.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary perspective view showing a vertical blind assembly including a plurality of conventional carriers;

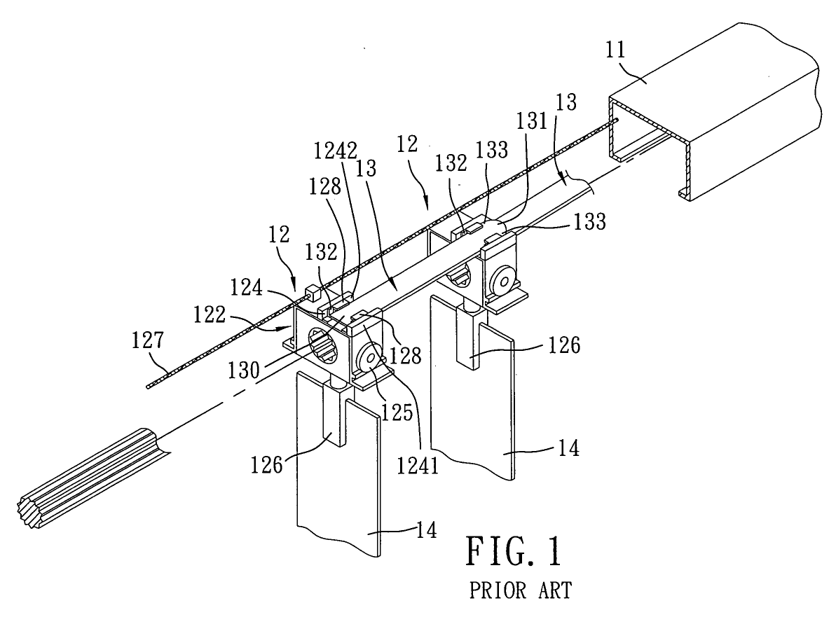

FIG. 2 is a schematic view showing the vertical blind assembly of FIG. 1 in a state of use;

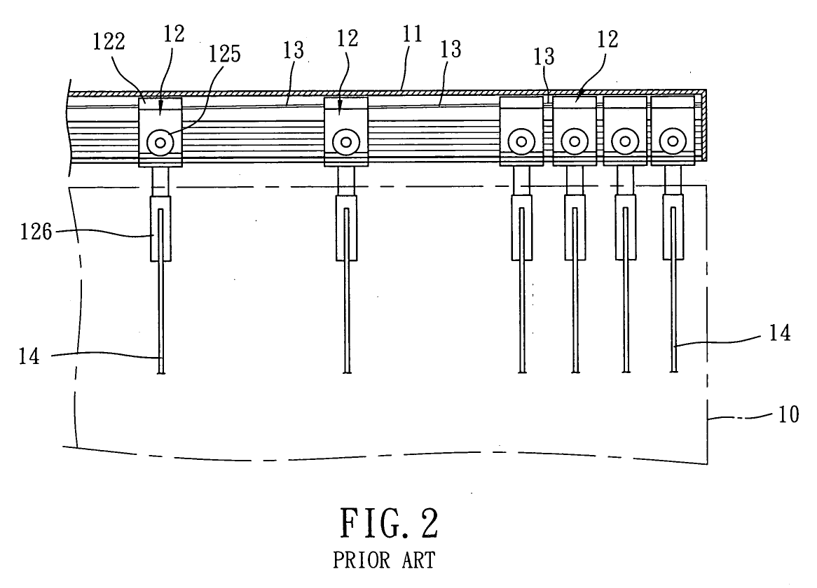

FIG. 3 is a partly exploded, fragmentary perspective view showing another vertical blind assembly including a plurality of conventional carriers;

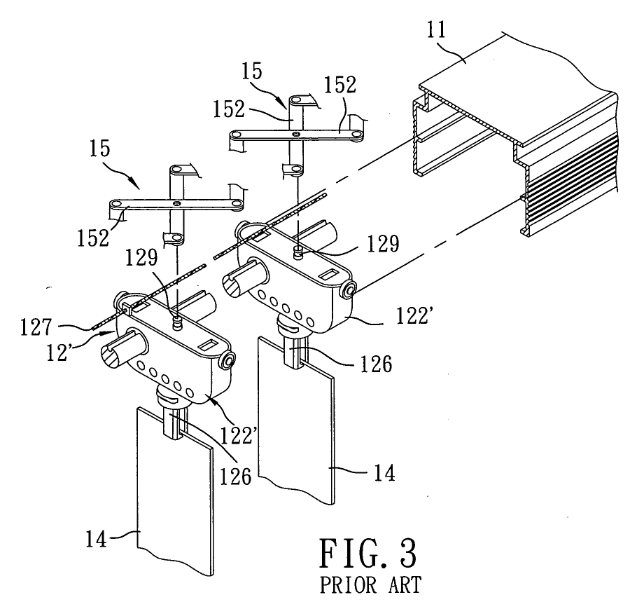

FIG. 4 is a partly exploded, fragmentary perspective view showing the preferred embodiment of a carrier according to the present invention when applied to a vertical blind assembly including pairs of intersecting spacer rods;

FIG. 5 is an exploded perspective view showing the preferred embodiment;

FIG. 6 is a fragmentary, partly sectional schematic side view showing the vertical blind assembly of FIG. 4 when in an extended state;

FIG. 7 is a partly sectional schematic top view showing the vertical blind assembly of FIG. 4 when in the extended state; and

FIG. 8 is a fragmentary perspective view showing the preferred embodiment without a pivot seat when applied to another vertical blind assembly including an elongate spacer plate.

### DETAILED DESCRIPTION OF THE PREFERRED EMBODIMENT

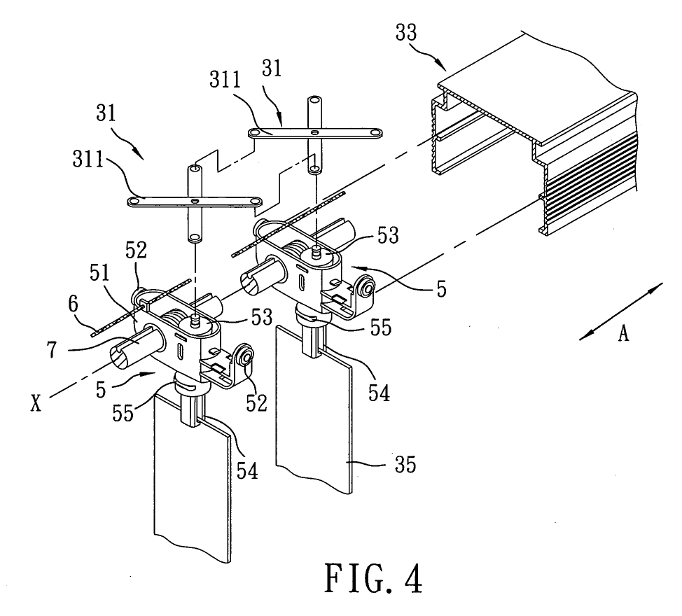

Referring to FIGS. 4, 5 and 6, the preferred embodiment of a carrier 5 according to the present invention is shown to be adapted for a vertical blind assembly that includes an elongate blind headrail 33 extending in a longitudinal direction (A) and disposed fixedly above a window 34, a plurality of spacer units 31, and a plurality of vertical slats 35. A plurality of the carriers 5 are embodied in the vertical blind assembly. Each spacer unit 31 includes two spacer rods 311 intersecting each other. Each carrier 5 includes a carrier body 51, a pivot seat 53, a slat-holding member 54, an engaging clamp 55, and a hollow worm rod 56.

The carrier body 51 of each carrier 5 is configured with an inner receiving space 503, and has a top side formed with a top opening 511 in spatial communication with the inner receiving space 503, a bottom side, opposite lateral sides 514, and front and rear sides 513, 515 each being disposed with a rolling wheel 52 that is adapted to be engaged slidably in the blind headrail 33. The carrier body 51 of each carrier 5 is formed with a receiving groove 516 extending between the lateral sides 514. The configuration of the carrier body 51 of one of the carriers 5 will be described in detail in the succeeding paragraph.

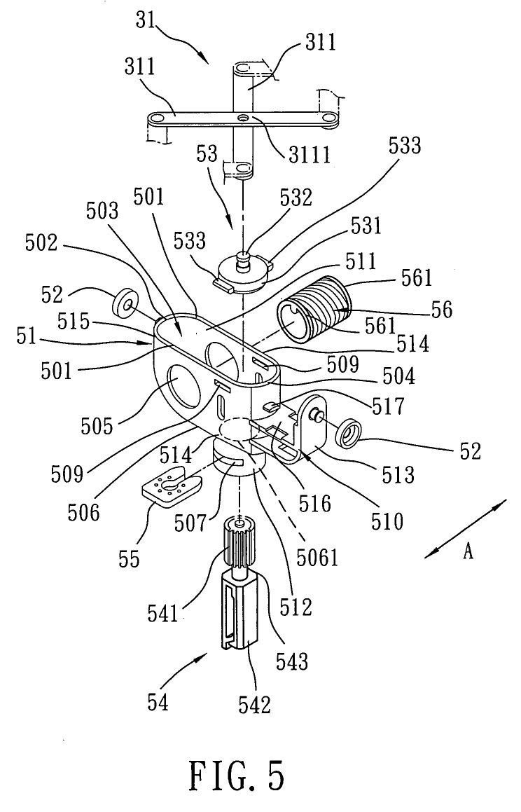

The carrier body 51 has front and rear walls 504, 502, two lateral walls 501 opposite to each other in the longitudinal direction (A) and interconnecting integrally the front and rear walls 504, 502, and a bottom wall 506 connected integrally to bottom edges of the front and rear walls 504, 502 and the lateral walls 501. The front and rear walls 504, 502 cooperate with the lateral walls 501 and the bottom wall 506 so as to define the inner receiving space 503 there among. Each lateral wall 501 is formed with an engaging hole 509 and a mounting hole 505. The carrier body 51 further has an L-shaped wall 510 extending frontwardly and then upwardly from the front wall 504. The front wall 504 cooperates with the L-shaped wall 510 so as to define the receiving groove 516 therebetween. More specifically, the rolling wheels 52 are disposed pivotally and respectively on the rear wall 503 and a vertical wall portion of the L-shaped wall 513. The carrier body 51 further has a mounting sleeve 512 extending downwardly from the bottom wall 506. The bottom wall 506 is formed with a through hole 5061 aligned with the mounting sleeve 512. The mounting sleeve 512 is formed with a horizontally extending insertion slot 507 (see FIG. 5).

The pivot seat 53 of each carrier 5 is mounted detachably on the top side of the corresponding carrier body 51, and has an upright pivot pin 532 adapted to be connected pivotally to intersecting portions 3111 of the spacer rods 311 of a corresponding spacer unit 31. For each carrier 5, the pivot seat 53 further has two engaging blocks 533 opposite to each other in the longitudinal direction (A) and engaging detachably and respectively the engaging holes 509 in the lateral walls 501 of the carrier body 51.

The slat-holding member 54 of each carrier 5 is mounted detachably on the bottom side, and is adapted to hold a corresponding one of the vertical slats 35. For each carrier 5, the slat-holding member 54 has a gear end portion 541 extending through the mounting sleeve 512 and the through hole 5061 in the bottom wall 506 of the carrier body 51 and into the inner receiving space 503, a slat-clamping end portion 542 opposite to the gear end portion 541, exposed from the mounting sleeve 512 and adapted to clamp the corresponding one of the vertical slats 35, and an intermediate neck portion 543 interconnecting the gear end portion 541 and the slat-clamping end portion 542 and positioned in the mounting sleeve 512.

For each carrier 5, the engaging clamp 55 is inserted through the insertion slot 507, and clamps rotatably the intermediate neck portion 543 of the slat-holding member 54, thereby allowing rotation of the intermediate neck portion 543 of the slat-holding member 54 in the mounting sleeve 512.

For each carrier 5, the worm rod 56 is disposed in the inner receiving space 503 in the carrier body 51, extends in the longitudinal direction (A), and has opposite ends 561 engaging respectively the mounting holes 505 in the lateral walls 501 of the carrier body 51. The worm rod 56 meshes with the gear end portion 541 of the slat-holding member 54. The worm rod 56 is operable so as to rotate about a rotating axis (X) (see FIG. 5) parallel to the longitudinal direction (A) to thereby drive rotation of the gear end portion 541 of the slat-holding member 54. As a result, orientation of the vertical slat 35 clamped by the slat-holding member 54 can be adjusted. The worm rods 56 of the carriers 5 are simultaneously operated in a known manner by an elongate driving rod 7 extending therethrough such that the vertical slats 35 are parallel to each other.

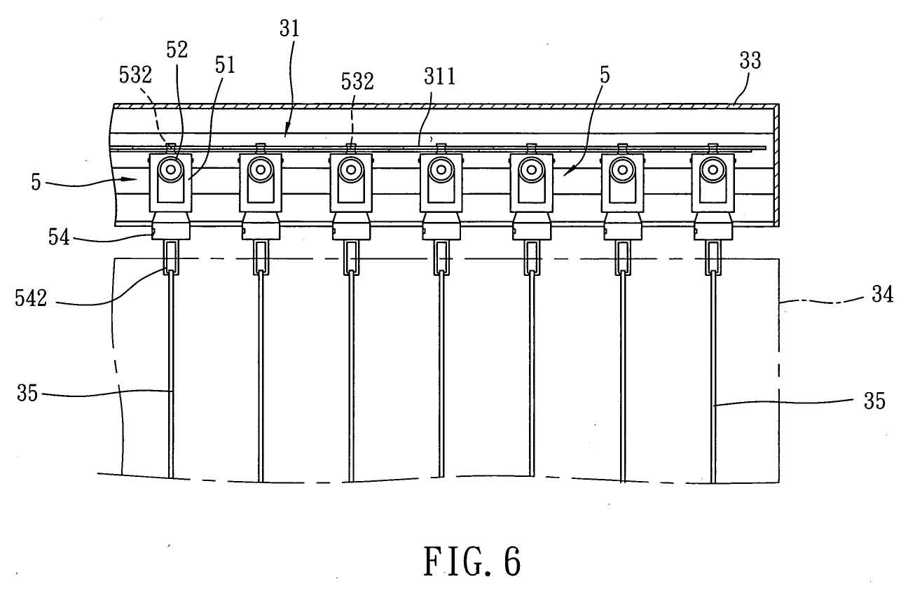

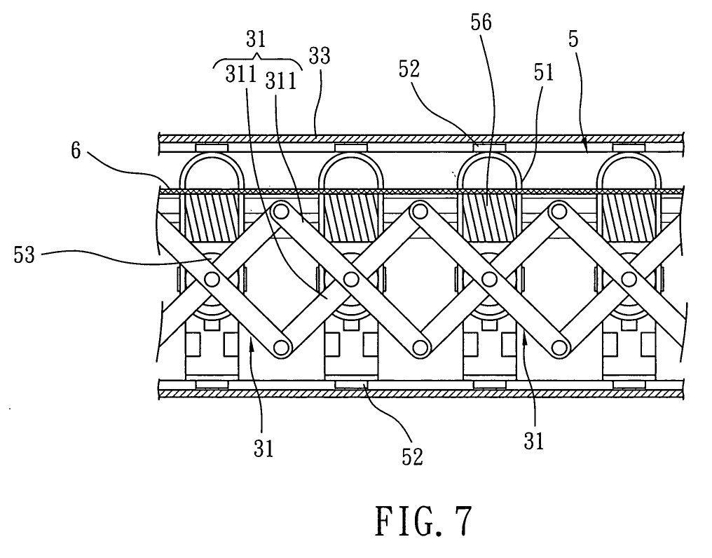

It is noted that ends of the spacer rods 311 of each of the spacer units 31 are connected pivotally and respectively to corresponding ends of the spacer rods 311 of an adjacent one of the spacer units 31, as shown in FIG. 7. Due to the presence of the spacer units 31 connected pivotally to each other, the carriers 5 can be pulled by a cord 6 attached to a leading carrier 5 (i.e., the left one in FIG. 4) to move within the blind headrail 33 to a desired one of extended and retracted positions, wherein the distance between each adjacent pair of the carriers 5 is uniform, as shown in FIG. 6.

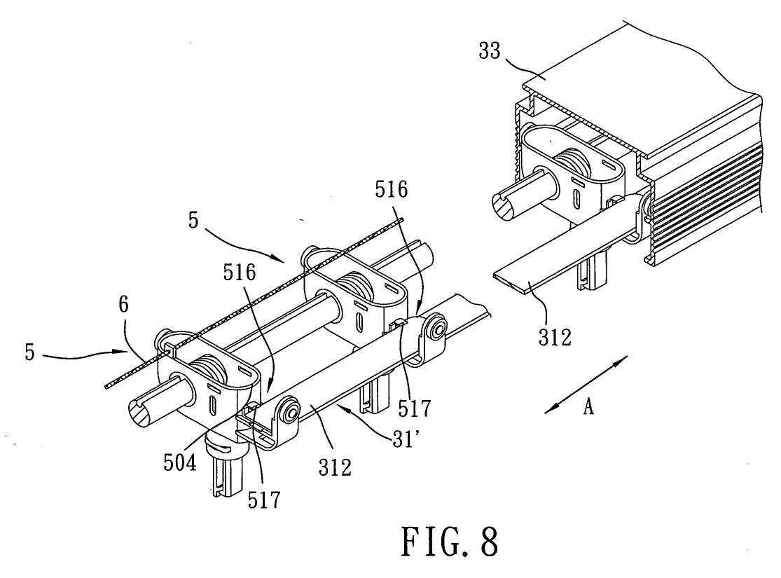

Referring to FIG. 8, the carrier 5 of the preferred embodiment is also applicable to another vertical blind assembly having the same configuration as that shown in FIG. 4 except that each spacer unit 31 is replaced 5 with a spacer unit 31′. Each spacer unit 31′ includes an elongate spacer plate 312 that extends in the longitudinal direction (A) and that is adapted to interconnect a corresponding adjacent pair of the carriers 5. For each carrier 5, the front wall 504 of the carrier body 51 has an outer surface formed with a frontwardly extending engaging block 517. Opposite engaging ends of the spacer plate 312 of each spacer unit 31′ engage respectively the engaging blocks 517 of the carrier bodies 51 of the corresponding adjacent pair of the carriers 5, thereby interconnecting the corresponding adjacent pair of the carriers 5. In this case, the pivot seats 53 are not used. When the leading carrier 5 is pulled by the cord 6 to move in an extended direction during an extending operation, each of the carriers 5 other than the leading one does not move until it is at a predetermined distance from an adjacent carrier 5 at the leading side. On the other hand, when the leading carrier 5 is pulled by the cord 6 to move in a retracted direction during a retracting operation, each of the carriers 5 other than the leading carrier 5 does not move back until it is collided by the adjacent carrier 5 at the leading side.

In sum, the carrier 5 of this invention can be easily assembled, disassembled and repaired as compared to the aforesaid conventional carriers, and is compatible with the vertical blind assemblies having the spacer units 31, 31′, thereby enhancing applicability.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A carrier adapted for a vertical blind assembly that includes an elongate blind headrail extending in a longitudinal direction, a spacer unit and a vertical slat, the spacer unit including two spacer rods intersecting each other, said carrier comprising:
a carrier body configured with an inner receiving space and having a top side formed with a top opening in spatial communication with said inner receiving space, a bottom side, opposite lateral sides, and front and rear sides each being disposed with a rolling wheel that is adapted to be engaged slidably in the blind headrail;
a pivot seat mounted detachably on said top side of said carrier body and having an upright pivot pin adapted to be connected pivotally to intersecting portions of the spacer rods; and
a slat-holding member mounted detachably on said bottom side and adapted to hold the vertical slat.

2. The carrier as claimed in claim 1, the spacer unit further including an elongate spacer plate that extends in the longitudinal direction, wherein said carrier body is formed with a receiving groove extending between said lateral sides and adapted for receiving the spacer plate therein.

3. The carrier as claimed in claim 2, wherein:
said carrier body has front and rear walls, two lateral walls opposite to each other in the longitudinal direction and interconnecting integrally said front and rear walls, and a bottom wall connected integrally to bottom edges of said front and rear walls and said lateral walls, said front and rear walls cooperating with said laterals walls and said bottom wall so as to define said inner receiving space there among; and
said carrier body further has an L-shaped wall extending frontwardly and then upwardly from said front wall, said front wall cooperating with said L-shaped wall so as to define said receiving groove therebetween.

4. The carrier as claimed in claim 3, wherein:
each of said lateral walls of said carrier body is formed with an engaging hole; and
said pivot seat further has two engaging blocks opposite to each other in the longitudinal direction and engaging detachably and respectively said engaging holes in said lateral walls of said carrier body.

5. The carrier as claimed in claim 3, wherein:
said carrier body further has a mounting sleeve extending downwardly from said bottom wall, said bottom wall being formed with a through hole aligned with said mounting sleeve; and
said slat-holding member has a gear end portion extending through said mounting sleeve and said through hole in said bottom wall and into said inner receiving space, a slat-clamping end portion opposite to said gear end portion, exposed from said mounting sleeve and adapted to clamp the vertical slat, and an intermediate neck portion interconnecting said gear end portion and said slat-clamping end portion and positioned in said mounting sleeve.

6. The carrier as claimed in claim 5, wherein said mounting sleeve is formed with a horizontally extending insertion slot, said carrier further comprising an engaging clamp inserted through said insertion slot and clamping rotatably said intermediate neck portion of said slat-holding member, thereby allowing rotation of said intermediate neck portion of said slat-holding member in said mounting sleeve.

7. The carrier as claimed in claim 5, wherein each of said lateral walls of said carrier body is formed with a mounting hole, said carrier further comprising a worm rod disposed in said inner receiving space in said carrier body, extending in the longitudinal direction and having opposite ends engaging respectively said mounting holes in said lateral walls of said carrier body, said worm rod meshing with said gear end portion of said slat-holding member, said worm rod being operable so as to rotate about a rotating axis parallel to the longitudinal direction to thereby drive rotation of said gear end portion of said slat-holding member.
